(19) United States
(12) Patent Application Publication
(10) Pub. No.: US 2003/0053281 A1
(43) Pub. Date: Mar. 20, 2003

(54) Method of compensating for deformation deterioration of piezoelectric/electrostrictive actuator

(75) Inventors: Yukihisa Takeuchi, Nishikamo-Gun (JP); Tsutomu Nanataki, Toyoake-City (JP); Takayoshi Akao, Nagoya-City (JP); Kazuhiro Yamamoto, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/230,772

(22) Filed: Aug. 29, 2002

(30) Foreign Application Priority Data
Aug. 31, 2001 (JP) 2001-264,480
Aug. 27, 2002 (JP) 2002-247,642

(51) Int. Cl. H01H 47/00

(52) U.S. Cl. 361/160

(57) ABSTRACT

While an on voltage or an off voltage for displacing an actuator is being applied to an electrode (column electrode) of the actuator, and an offset voltage is being applied to the other electrode (row electrode), the polarity of these voltages is periodically or temporarily switched to keep the magnitude of the displacement of the actuator for thereby extending the service life of the actuator.

### BACKGROUND OF THE INVENTION

1. Field of the Invention

The present invention relates to a method of compensating for a deterioration of the displacing action of a laminated piezoelectric/electrostrictive actuator which comprises electrode layers and a piezoelectric/electrostrictive layer of ceramics, for thereby extending the service life of the actuator.

2. Description of the Related Art

Heretofore, there have been known piezoelectric/electrostrictive actuators capable of controlling minute displacements in submicrons. Particularly, laminated piezoelectric/electrostrictive actuators lend themselves to the control of minute displacements. The laminated piezoelectric/electrostrictive actuators are also advantageous in that they have a high electromechanical energy conversion efficiency, a high response capability, a high durability, and a low electric power consumption. The laminated piezoelectric/electrostrictive actuators comprise a piezoelectric/electrostrictive layer of piezoelectric ceramics and electrode layers to which a voltage is applied, the piezoelectric/electrostrictive layer and the electrode layers being laminated together. The laminated. piezoelectric/electrostrictive actuators with the above advantages are used in piezoelectric pressure sensors, probe moving mechanisms for scanning-type tunnel microscopes, linear motion guide mechanisms for ultraprecision machining apparatus, servo valves for hydraulic pressure control, heads in VTRs, pixels of flat-panel image display apparatus, and heads in ink jet printers.

When a positive or negative DC voltage is applied to one of the electrode layers with the other electrode layer being connected to ground, the piezoelectric/electrostrictive layer exhibits an electrostrictive effect to produce a mechanical displacement in the laminated direction of the piezoelectric/electrostrictive layer and the electrode layers.

The piezoelectric/electrostrictive layer which produces a mechanical displacement serves as an operating element of the piezoelectric/electrostrictive actuator. When a drive voltage having a certain amplitude is applied to the electrode layers, the operating element is vertically displaced by a certain amplitude. The piezoelectric/electrostrictive actuator may be shaped such that a displacement transmitting member for transmitting the displacement of the operating element upwardly is either placed on the operating element or formed together with the operating element. It has been found that when the piezoelectric/electrostrictive actuator is repeatedly displaced continuously, the displacement of the actuator after it has been operated for a long period of time becomes much smaller than the displacement of the actuator at the time it starts operating.

If a deterioration of the displacement of the actuator can be confirmed in some way in an apparatus in which the actuator is employed, then it is necessary to replace the actuator with a new one. However, the actuator is usually formed by a film fabrication process based on screen printing technology, and the actuator is electrically connected to an electronic circuit in the apparatus by a precision interconnection process such as wire bonding, for example. Therefore, it is not easy to replace the actuator with a new one. For this reason, a deterioration of the displacement of the actuator results in not only a reduction in the reliability of the actuator, but also a reduction in the service life of the apparatus which incorporates the actuator.

### SUMMARY OF THE INVENTION

It is therefore an object of the present invention to provide a method of compensating for a deterioration of the displacement of a laminated piezoelectric/electrostrictive actuator comprising electric layers formed on a ceramic base by a film fabrication process, and a piezoelectric/electrostrictive layer of ceramics, by periodically or temporarily switching the polarity of a voltage applied to the electrode layers for thereby maintaining the displacement of the piezoelectric/electrostrictive actuator, extending the service life of the piezoelectric/electrostrictive actuator and increasing the reliability of an apparatus which incorporates the piezoelectric/electrostrictive actuator.

According to the present invention, there is provided a method of compensating for a deterioration of the displacement of a laminated piezoelectric/electrostrictive actuator which comprises electrode layers formed by a film fabrication process and a piezoelectric/electrostrictive layer of ceramics, mounted on a ceramic base, comprising the step of periodically or temporarily switching the polarity of a voltage applied to the piezoelectric/electrostrictive actuator through the electrode layers.

When a voltage of one polarity is applied to a piezoelectric/electrostrictive actuator to displace the piezoelectric/electrostrictive actuator repeatedly, the displacement of the piezoelectric/electrostrictive actuator is reduced, i.e. the hysteresis characteristics of said polarity become unsuitable to displace piezoelectric/electrostrictive actuator sufficiently. However, the polarity of the voltage is switched to use hysteresis characteristics of the piezoelectric/electrostrictive actuator at the opposite polarity of the voltage, which hysteresis characteristics are in an initial state, for thereby maintaining the displacement of the piezoelectric/electrostrictive actuator.

By thus compensating for the reduction in the displacement, the reliability of the piezoelectric/electrostrictive actuator and hence the reliability of an apparatus which incorporates the piezoelectric/electrostrictive actuator are increased. The polarity of the voltage applied to the piezoelectric/electrostrictive actuator may be switched at any desired time. If the polarity of the voltage applied to the piezoelectric/electrostrictive actuator is switched before the displacement of the piezoelectric/electrostrictive actuator is reduced to be lower than the required displacement, the required displacement of the piezoelectric/electrostrictive actuator can be maintained continuously.

The polarity of the voltage may be periodically or temporarily switched by controlling a voltage polarity switching circuit which is connected between a source for generating the voltage applied to the piezoelectric/electrostrictive actuator layer through the electrode layers and the electrode layers.

Preferably, the method further comprises the steps of monitoring a displaced state of the piezoelectric/electrostrictive actuator, and switching the polarity of the voltage applied to the piezoelectric/electrostrictive actuator when a displacing action of the piezoelectric/electrostrictive actuator is deteriorated.

Specifically, a monitoring piezoelectric/electrostrictive actuator is provided separately from the piezoelectric/electrostrictive actuator in use, the polarity of the voltage applied to the piezoelectric/electrostrictive actuator in use is switched based on a deterioration of the displacement of the monitoring piezoelectric/electrostrictive actuator. At this time, the polarity of the voltage applied to the piezoelectric/electrostrictive actuator in use may remotely be switched. The above expression “in use” means to be actually used as a main component of apparatus, not to be the monitoring piezoelectric/electrostrictive actuator.

The method may further comprise the steps of providing a timer, and switching the polarity of the voltage applied to the piezoelectric/electrostrictive actuator when one of a plurality of items of time information representing times when the displacement of the piezoelectric/electrostrictive actuator is likely to deteriorate agrees with time information indicated by the timer.

The piezoelectric/electrostrictive actuator may comprise a piezoelectric/electrostrictive actuator for use in a display apparatus for displaying an image depending on an image signal based on the displacement of the piezoelectric/electrostrictive actuator. The method may further comprise the step of switching the polarity of the voltage applied to the piezoelectric/electrostrictive actuator between a period in which the image is displayed and a period in which the image is not displayed.

According to such a pattern of applied voltages, not only the piezoelectric/electrostrictive actuator, but also the display apparatus, can have an extended service life. In addition, the high quality of images displayed on the display apparatus can be maintained over a long period of time. In the period in which the image is not displayed, the voltage polarity may be switched to prevent the displayed image from being interrupted and also prevent the viewer of the display apparatus from feeling uncomfortable. The magnitude of the displacement of the piezoelectric/electrostrictive actuator may be maintained by switching the voltage polarity not only in the display apparatus, but also in any apparatus which use the piezoelectric/electrostrictive actuator.

The method may further comprise the step of applying a voltage based on a refresh signal having a constant frequency to the piezoelectric/electrostrictive actuator in at least a portion of the period in which the image is not displayed.

The refresh signal has a duty factor in a pulse waveform having a pulse period, and the voltage is applied to the piezoelectric/electrostrictive actuator is based on the duty factor in which the period for emitting light is less than 50% of the pulse period.

The frequency of the refresh signal is preferably equal to or higher than the frame frequency of the image signal. A range of voltages applied to the piezoelectric/electrostrictive actuator based on the refresh signal is preferably greater than a range of voltages applied to the piezoelectric/electrostrictive actuator in the period in which the image is displayed. A temperature at which the voltage is applied to the piezoelectric/electrostrictive actuator based on the refresh signal is preferably equal to or higher than a temperature at which the voltage is applied to the piezoelectric/electrostrictive actuator in the period in which the image is displayed.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view of a display apparatus to which a method of compensating for a deterioration of the displacement of a laminated piezoelectric/electrostrictive actuator according to the present invention is applied;

FIG. 2 is a fragmentary cross-sectional view of a display element of the display apparatus;

FIG. 3 is a view showing a picture element arrangement of the display element;

FIG. 4 is a fragmentary cross-sectional view of a display element with a thin spacer layer;

FIG. 5 is a fragmentary cross-sectional view of a specific structure of an actuator and a picture element assembly;

FIG. 6 is a fragmentary cross-sectional view of another arrangement of a display element;

FIG. 7 is a diagram showing an example of the relationship between an offset potential (bias potential) outputted from a row electrode drive circuit, the potentials of on- and off-signals outputted from a column electrode drive circuit, and voltages applied between row and column electrodes;

FIG. 8 is a circuit diagram showing, partly in block form, a drive device;

FIG. 9 is a diagram showing another example of the relationship between an offset potential (bias potential) outputted from a row electrode drive circuit, the potentials of on- and off-signals outputted from a column electrode drive circuit, and voltages applied between row and column electrodes;

FIG. 10 is a diagram showing still another example of the relationship between an offset potential (bias potential) outputted from a row electrode drive circuit, the potentials of on- and off-signals outputted from a column electrode drive circuit, and voltages applied between row and column electrodes;

FIG. 11A is a diagram showing displacement patterns of an actuator with respect to patterns of positive and negative logic voltages applied to a piezoelectric/electrostrictive layer;

FIG. 11B is a diagram showing the hysteresis characteristics of the actuator;

FIG. 11C is a diagram showing the hysteresis characteristics of an actuator after the pattern of positive logic voltages is applied to the piezoelectric/electrostrictive layer repeatedly for a long period of time;

FIG. 11D is a diagram showing the hysteresis characteristics of an actuator after the pattern of negative logic voltages is applied to the piezoelectric/electrostrictive layer repeatedly for a long period of time;

FIG. 12 is a block diagram illustrative of methods according to first and second specific examples using a voltage polarity switching circuit;

FIG. 13 is a block diagram illustrative of a method according to a third specific example using a voltage polarity switching circuit;

FIG. 14 is a block diagram illustrative of a method according to a fourth specific example using a voltage polarity switching circuit;

FIG. 15 is a timing chart showing 24 hours a day which are divided into an active time zone, an inactive time zone, and a turn-off time zone;

FIG. 16 is a block diagram of a circuit for a refresh operation;

FIG. 17A is a diagram showing the waveform of a voltage applied to an actuator in the active time zone;

FIG. 17B is a diagram showing the waveform of a voltage applied to an actuator in the inactive time zone; and

FIG. 18 is a diagram showing an experimental example of changes in the displacement of an actuator.

### DESCRIPTION OF THE PREFERRED EMBODIMENTS

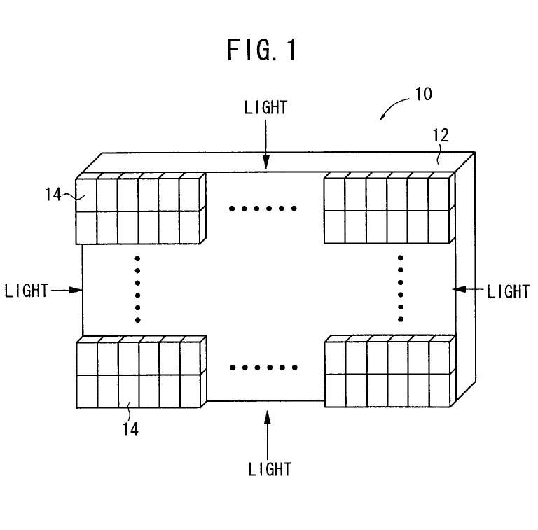

A method of compensating for a deterioration of the displacement of a laminated piezoelectric/electrostrictive actuator according to the present invention, which is applied to a display apparatus will be described below with reference to FIGS. 1 through 18.

As shown in FIG. 1, a display apparatus 10, to which a method of compensating for a deterioration of the displacement of a laminated piezoelectric/electrostrictive actuator according to the present invention is applied, comprises a light guide panel 12 having a display area for the display apparatus 10 and a plurality of display elements 14 mounted as a matrix on a rear surface of the light guide panel 12.

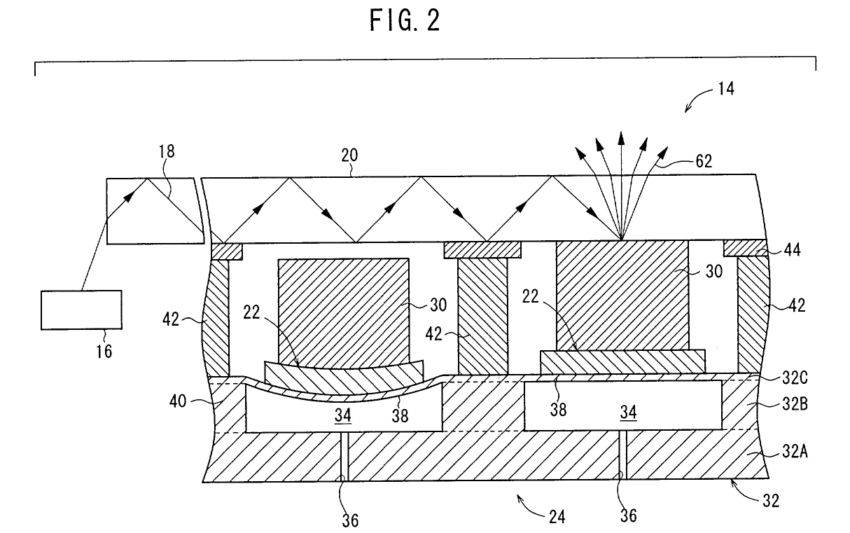

As shown in FIG. 2, each of the display elements 14 comprises an optical waveguide plate 20 into which light 18 emitted from a light source 16, and a drive unit 24 provided in confronting relation to a rear surface of the optical waveguide plate 20 and having a matrix or staggered array of actuators 22 aligned with respective picture elements.

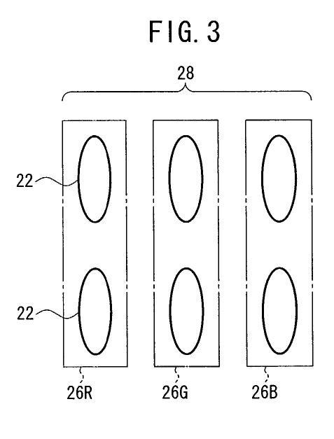

As shown in FIG. 3, two actuators 22 arrayed in a vertical direction make up a single dot, and three dots including a red dot 26R, a green dot 26G, and a blue dot 26B which are arrayed in a horizontal direction make up a single picture element 28. The picture elements 28 of the display element 14 shown in FIG. 1 are arranged in horizontal rows each containing 16 picture elements (48 dots) and vertical columns each containing 16 picture elements (16 dots).

As shown in FIG. 1, the display elements 14 of the display apparatus 10 are arranged on the rear surface of the light guide panel 12 in horizontal rows each containing 40 display elements 14 and vertical columns each containing 30 display elements 14, so that 640 picture elements (1920 dots) are arrayed horizontally and 480 picture elements (480 dots) are arrayed vertically according to VGA standards.

The light guide panel 12 comprises a panel such as a glass panel, an acrylic panel, or the like whose light transmittance in the visible light wavelength range is large and uniform. The display elements 14 are connected by wire bonding or soldering using end connectors, rear connectors, or the like, so that they can be supplied with necessary signals through connections therebetween.

The light guide panel 12 and the optical waveguide plate 20 of the display elements 14 should preferably be comprised of materials having similar refractive indexes. The light guide panel 12 and the optical waveguide plate 20 may be bonded to each other by a transparent adhesive or liquid that should preferably have a high and uniform light transmittance in the visible light wavelength range. The refractive index of the transparent adhesive or liquid should preferably be close to the refractive indexes of the light guide panel 12 and the optical waveguide plate 20 for achieving a desired level of brightness on the display screen of the display apparatus 10.

As shown in FIG. 2, each display element 14 also includes picture element assemblies 30 stacked respectively on the actuators 22.

The driving section 24 includes an actuator substrate 32 composed of, for example, ceramics. Two actuators 22 are arranged at portions at which the respective picture elements 28 of the actuator substrate 32 are to be formed. The actuator substrate 32 has its first principal surface which is arranged to oppose to the back surface of the optical waveguide plate 20. The first principal surface is a continuous surface (flushed surface). Hollow spaces 34 which are formed respective vibrating sections as described later are provided in the actuator substrate 32 at positions corresponding to the portions at which the respective picture elements 28 are to be formed. The respective hollow spaces 34 communicate with the outside via through-holes 36 which has a small diameter and which are provided at the second end surface of the actuator substrate 32.

The portion of the actuator substrate 32, at which the hollow space 34 is formed, is thin-walled. The other portion of the actuator substrate 32 is thick-walled. The thin-walled portion has a structure which tends to undergo vibration in response to external stress, and it functions as a vibrating section 38. The portion other than the hollow space 34 is thick-walled, and it functions as a fixed section 40 for supporting the vibrating section 38.

The actuator substrate 32 has a stacked structure comprising a substrate layer 32A as a lowermost layer, a spacer layer 32B as an intermediate layer, and a thin plate layer 32C as an uppermost layer. The actuator substrate 32 can be recognized as an integrated structure including the hollow spaces 34 formed at the positions in the spacer layer 32B corresponding to the actuators 22. The substrate layer 32A functions as a substrate for reinforcement, as well as it functions as a substrate for circuit patterns. The actuator substrate 32 may be sintered in an integrated manner, or it may be additionally attached.

Those preferably adopted for the constitutive materials for the substrate layer 32A, the spacer layer 32B, and the thin plate layer 32C include those provided with all of the high heat resistance, the high strength, and the high toughness, such as fully stabilized zirconium oxide, partially stabilized zirconium oxide, aluminum oxide, magnesium oxide, titanium oxide, spinel, and mullite. An identical material may be used for all of the substrate layer 32A, the spacer layer 32B, and the thin plate layer 32C. Alternatively, different materials may be used for the substrate layer 32A, the spacer layer 32B, and the thin plate layer 32C respectively.

The thickness of the thin plate layer 32C is usually not more than 50 μm and preferably about 3 to 20 μm in order to greatly displace the actuator 22.

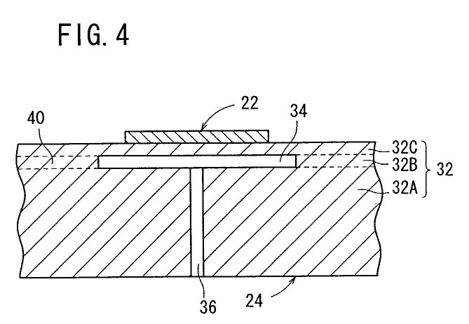

The spacer layer 32B constitutes the hollow space 34 in the actuator substrate 32, and the thickness of the space layer 32B is not specifically limited. For example, the thickness may be determined depending on the function the hollow space 34. Especially, it is preferable that the thickness possessed by the spacer layer 32B is not more than a thickness which is necessary for the actuator 22 to function. For example, as shown in FIG. 4, it is preferable that the spacer layer 32B is thin. It is preferable that the thickness of the spacer layer 32B is equivalent to the magnitude of the displacement of the actuator 22 to be used.

Owing to the arrangement as described above, the flexion of the thin-walled portion (portion of the vibrating section 38) is restricted by the substarate layer 32A which is disposed closely in the flexion direction to prevent the thin-walled portion from destruction which would be otherwise caused by unitentional application of any external force. It is also possible to stabilize the displacement of the actuator 22 to have a specified value by utilizing the effect to restrict the flexion brought about by the substrate layer 32A.

When the spacer layer 32B is made thin, then the thickness of the actuator substrate 32b itself is decreased, and it is possible to decrease the flexural rigidity. Accordingly, for example, when the actuator substrate 32 is bonded and fixed to another member, then the warpage or the like of the subject (in this case, the actuator substrate 32) is effectively reformed with respect to the object (for example, the optical waveguide plate 20), and it is possible to improve the reliability of the bonding and the fixation.

Additionally, the actuator substrate 32 is constructed to be thin as a whole, ans hence it is possible to reduce the amount of use of raw materials when the actuator substrate 32 is produced. This structure is also advantageous in view of the production cost. Therefore, in particular, it is preferable that the thickness of the spacer layer 32B is 3 to 20 μm.

The thickness of the substrate layer 32A is generally not less than 50 μm and preferably about 80 to 300 μm in order to reinforce the entire actuator substrate 32, because the spacer layer 32B is constructed to be thin as described above.

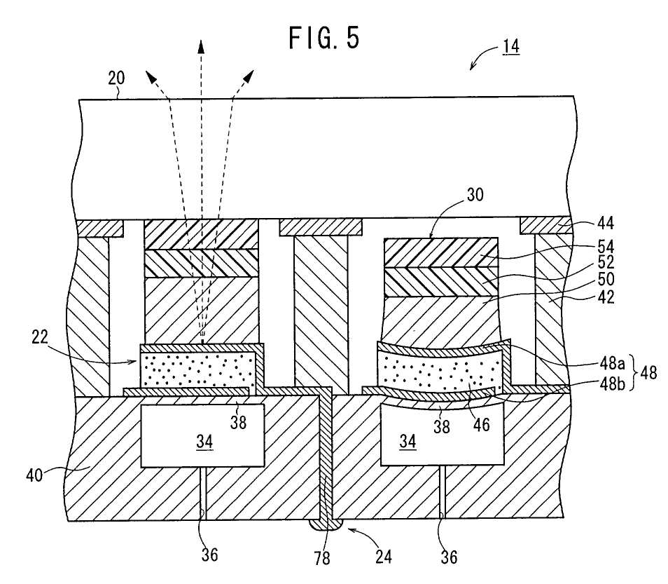

A specific example of the actuator 22 and the picture element assembly 30 will be described below with reference to FIG. 5. In FIG. 5, light shielding layers 44 are allowed to interposed between the crosspieces 42, which are composed of a material that is resistant to deformation under forces, and the optical waveguide plate 20.

As shown in FIG. 5, the actuator 22 has, in addition to the vibrating section 38 and the fixed section 40, a piezoelectric/electrostrictive layer 46 formed directly on the vibrating section 38, and a pair of electrodes 48 formed respectively on upper and lower surfaces of the piezoelectric/electrostrictive layer 46. The electrodes 48 comprise an upper row electrode 48a and a lower column electrode 48b.

A pair of electrodes 48 may be provided on the upper and lower surfaces of the piezoelectric/electrostrictive layer 46, as shown in FIG. 5, or may be provided on the oneside of the piezoelectric/electrostrictive layer 46, or on the upper surface of the piezoelectric/electrostrictive layer 46.

If a pair of electrodes 48 is provided on the upper surface of the piezoelectric/electrostrictive layer 46, then a pair of electrodes 48 may comprise comb-shaped teeth provided in an interdigitating relation to each other, or may be of a spiral shape or a multi-branch shape as disclosed in Japanese Laid-Open Patent Publication No. 10-78549.

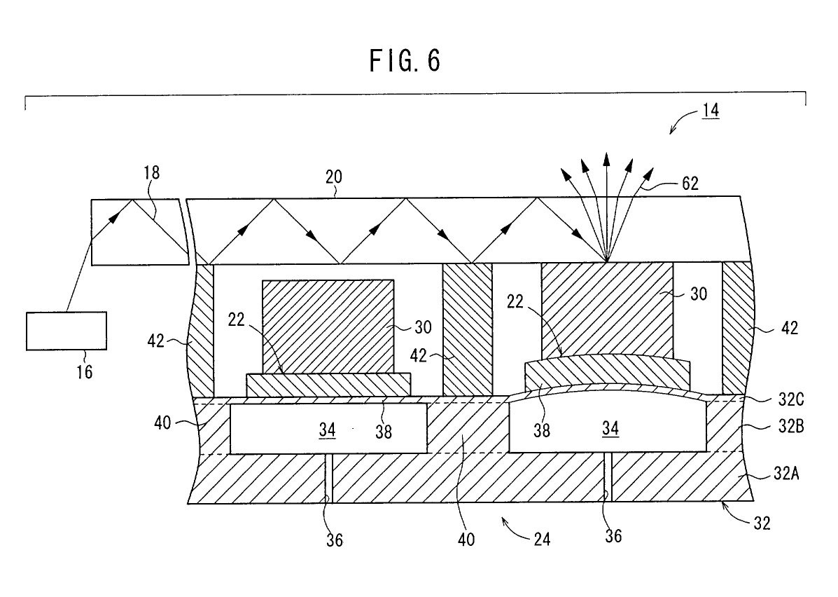

If the row electrode 48a is provided on the upper surface of the piezoelectric/electrostrictive layer 46 and the column electrode 48b is provided on the lower surface of the piezoelectric/electrostrictive layer 46, as shown in FIG. 5, then the actuator elements 22 are possible to displaced in one direction so as to be convex toward the hollow space 34, as shown in FIGS. 2 and 5. Alternatively, the actuator 22 are possible to displaced so as to be convex toward the optical waveguide plate 20, as shown in FIG. 6. In the example shown in FIG. 6, the light shielding layers 44 (see FIG. 2) are not included.

As shown in FIG. 5, the picture element assembly 30 is a displacement-transmitting section of the actuator elements 22 which is stacked body comprising a white scattering body 50, a color filter 52, and a transparent layer 54.

The above stacked body may be modified as follows: (1) The white scattering body 50 is replaced with a light-reflective layer and an insulating layer which are stacked together. (2) The displacement transmitting section provided the picture element assembly 30 on the actuator 22 comprises a stacked body of a colored scattering body and a transparent layer. (3) The displacement transmitting section comprises a stacked body of a taransparent layer, a colored scattering body, a light shielding layer, and an insulating layer.

As shown in FIGS. 2, 5, and 6, the crosspieces 42 are interposed between the optical waveguide plate 20 and the actuator substrate 32 and positioned around the picture element assemblies 30. In the example shown in FIG. 6, the optical waveguide plate 20 is directly fixed to the upper surfaces of the crosspieces 42. The crosspieces 42 should preferably be composed of a material which is resistant to deformation when subjected to heat or pressure.

The selection of materials of the piezoelectric/electrostrictive layer 46 and the pair of electrodes (the row electrode 48a and the column electrode 48b) will be described below.

The piezoelectric/electrostrictive layer 46 may be composed of ceramics containing, singly or in combination, lead zirconate, lead manganese tungstate, bismuth sodium titanate, sodium potassium niobate, bismuth strontium tantalate, lead magnesium niobate, lead nickel niobate, lead zinc niobate, lead manganese niobate, lead magnesium tantalate, lead nickel tantalate, lead antimony tinate, lead titanate, barium titanate, lead magnesium tungstate, and lead cobalt niobate.

The chief component may contain 50% by weight or more of one of the above compounds. The ceramics containing lead zirconate is the most frequently used material of the piezoelectric/electrostrictive layer 46.

If the piezoelectric/electrostrictive layer 46 is composed of ceramics, then an oxide of lanthanum, calcium, strontium, molybdenum, tungsten, barium, niobium, zinc, nickel, manganese, cerium, cadmium, chromium, cobalt, antimony, iron, yttrium, tantalum, lithium, bismuth, tin, or the like, or a combination thereof, or other compounds, may be added to the ceramics.

For example, the piezoelectric/electrostrictive layer 46 may be composed of ceramics containing a chief component composed of lead magnesium niobate, lead zirconate, and lead titanate, and further containing lanthanum and strontium.

The piezoelectric/electrostrictive layer 46 may be dense or porous. If the piezoelectric/electrostrictive layer 46 is porous, then the porosity should preferably be 40% or less.

The piezoelectric/electrostrictive layer 46 may be formed on the vibrating section 38 by a screen printing process, any of various thick film forming processes including a dipping process, a coating process, and an electrophoretic process, or any of various thin film forming processes including an ion beam process, a sputtering process, a vacuum evaporation process, an ion plating process, a chemical vapor deposition (CVD) process, and a plating process. In this embodiment, a screen printing process, or any of various thick film forming processes including a dipping process, a coating process, and an electrophoretic process, is preferably used to form the piezoelectric/electrostrictive layer 46 on the vibrating section 38.

According to these processes, the piezoelectric/electrostrictive layer 46 can be formed using a paste, a slurry, or a suspension, an emulsion, or a sol which is mainly composed of particles of piezoelectric ceramics having an average particle diameter ranging from 0.01 to 5 μm, preferably from 0.05 to 3 μm. Good piezoelectric properties can be achieved by the piezoelectric/electrostrictive layer 46 thus formed.

Especially, the electrophoretic process is capable of forming films at a high density to a high shape accuracy, and also has such features as described in “Electrochemistry and Industrial physical chemistry”, Vol. 53, No. 1 (1985), pages 63-68, written by Kazuo Anzai, and “Process of forming high-order ceramics according to electrophoresis, 1st research forum”, collected preprints (1998), pages 5-6, pages 23-24. One of the processes described above should be selected in view of the required accuracy and reliability in forming the piezoelectric/electrostrictive layer 46 on the vibrating section 38.

The thickness of the vibrating section 38 and the thickness of the piezoelectric/electrostrictive layer 46 should preferably be of substantially the same level. If the thickness of the vibrating section 38 were extremely larger than the thickness of the piezoelectric/electrostrictive layer 46 by at least ten times, then since the vibrating section 38 would work to prevent the piezoelectric/electrostrictive layer 46 from contraction when it is sintered, large stresses would be developed in the interface between the piezoelectric/electrostrictive layer 46 and the actuator substrate 32, making the piezoelectric/electrostrictive layer 46 easy to peel off the actuator substrate 32. If the thickness of the vibrating section 38 is substantially the same as the thickness of the piezoelectric/electrostrictive layer 46, the actuator substrate 32 (the vibrating section 38) is easy to follow the piezoelectric/electrostrictive layer 46 as it contractions when it is sintered, allowing the vibrating section 38 and the piezoelectric/electrostrictive layer 46 to be appropriately combined with each other. Specifically, the thickness of the vibrating section 38 should preferably be in the range from 1 to 100 μm, more particularly in the range from 3 to 50 μm, and even more particularly in the range from 5 to 20 μm. The thickness of the piezoelectric/electrostrictive layer 46 should preferably be in the range from 5 to 100 μm, more particularly in the range from 5 to 50 μm, and even more particularly in the range from 5 to 30 μm.

The row electrode 48a and the column electrode 48b provided respectively on the upper and lower surfaces of the piezoelectric/electrostrictive layer 46 or the pair of electrodes 48 have a suitable thickness depending on how they are used. The electrodes 48 should preferably have a thickness ranging from 0.01 to 50 μm and more preferably have a thickness ranging from 0.1 to 5 μm. The row electrode 48a and the column electrode 48b should preferably be composed of an electrically conductive metal which is solid at room temperature. For example, the row electrode 48a and the column electrode 48b may be composed of a metal such as aluminum, titanium, chromium, iron, cobalt, nickel, copper, zinc, niobium, molybdenum, ruthenium, palladium, rhodium, silver, tin, tantalum, tungsten, iridium, platinum, gold, lead, etc., singly or as an alloy. The row electrode 48a and the column electrode 48b may contain any of the above elements in a desired combination.

An electrically conductive material may be prepared by adding a metal oxide such as aluminum oxide, titanium oxide, zirconium oxide, cerium oxide, copper oxide, or the like to the above metal or alloy, or by dispersing the same material as the constituent material of the actuator substrate 32 and/or the above piezoelectric/electrostrictive material in the above metal or alloy. If electrodes composed of the above electrically conductive material are used, then they are effective to reduce a time-dependent displacement produced when the actuator 22 is displaced. Use of such electrodes is also effective in increasing the interval of electrode polarity switching due to a displacement deterioration.

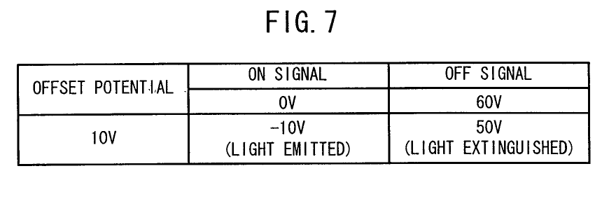

Operation of the display apparatus 10 will briefly be described below with reference to FIGS. 2, 5, 7, and 8. In operation, as shown in FIG. 7, an offset voltage, of 10 V, for example, is applied to the row electrode 48a of each of the actuators 22, and an on-signal of 0 V and an off-signal of 60 V, for example, are applied to the column electrode 48b of each of the actuators 22.

Therefore, in those actuators 22 where the on signal is applied to the column electrode 48b with the row electrode 48a as a potential reference, a low level voltage of −10 V is applied between the column electrode 48b and the row electrode 48a, and in those actuators 22 where the off signal is applied to the column electrode 48b, a high level voltage of 50 V is applied between the column electrode 48b and the row electrode 48a.

Light 18 is introduced into the optical waveguide plate 20 from an end thereof, for example. The optical waveguide plate 20 has its refractive index pre-adjusted to cause all the light 18 to be totally reflected within the optical waveguide plate 20 without passing through front and rear surfaces thereof while the picture element assemblies 30 are not in contact with the optical waveguide plate 20. The refractive index n of the optical waveguide plate 20 is preferably in the range from 1.3 to 1.8, and more preferably from 1.4 to 1.7.

In the present embodiment, while the actuators 22 are in their neutral state, since the end faces of the picture element assemblies 30 are held in contact with the rear surface of the optical waveguide plate 20 by a distance equal to or smaller than the wavelength of the light 18, the light 18 is reflected by the end faces of the picture element assemblies 30 and becomes scattered light 62. The scattered light 62 is partly reflected in the optical waveguide plate 20, but mostly passes through the front surface of the optical waveguide plate 20 without being reflected therein. All the actuators 22 are in the on state, emitting light in a color corresponding to the color of the color filters 52 and the white scattering bodies 50 in the picture element assemblies 30. Because all the actuators 22 are in the on state, a white color is displayed on the display screen of the display apparatus 10.

When the low level voltage of −10 V is applied as an on voltage, the end faces of the picture element assemblies 30 are brought into contact with the rear surface of the optical waveguide plate 20, holding the actuators 22 more reliably in the on state for stable display.

When an off signal is applied to the actuator 22 corresponding to a certain dot 26, the actuator 22 is flexibly displaced so as to be convex toward the hollow space 34, spacing the end face of the picture element assembly 30 away from the optical waveguide plate 20, as shown in FIG. 2. The actuator 22 is now turned off, extinguishing the light which has been emitted thereby.

Therefore, the display apparatus 10 controls light emission (light leakage) on the front surface of the optical waveguide plate 20 depending on whether the picture element assemblies 30 contact the optical waveguide plate 20 or not.

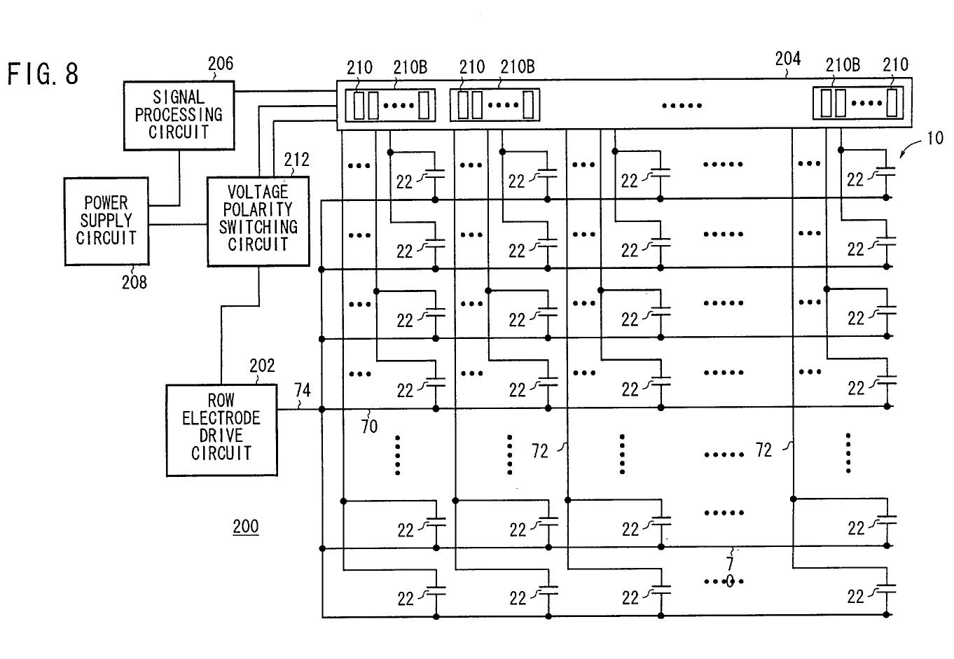

In the display elements 14, interconnections 70 connected to the row electrodes 48a and the column electrodes 48b have, as shown in FIG. 8, as many interconnections 70 as the number of the columns of actuators 22 and as many data lines 72 as the number of all actuators 22. The interconnections 70 are connected to a common interconnection 74.

Each of the interconnections 70 extends from the row electrode 48a of an actuator 22 in a preceding column and is connected to the row electrode 48a of an actuator 22 in a next column. Therefore, the row electrodes 48a of the actuators 22 are connected by the interconnections 70 in series with each other in each row. The column electrodes 48b of the actuators 22 and the data lines 72 are electrically connected to each other via through holes 78 defined in the actuator substrate 32.

As shown in FIG. 8, a drive device 200 for the actuators 22 comprises a row electrode drive circuit 202, a column electrode drive circuit 204, a signal processing circuit 206 for controlling at least the column electrode drive circuit 204, a power supply circuit 208 for supplying a drive voltage, and a voltage polarity switching circuit 212 for switching the polarity of the voltage supplied from the power supply circuit 208. These circuits 202, 204, 206, 208, 212 are mounted on peripheral edges of the display apparatus 10.

The row electrode drive circuit 202 is connected to supply an offset voltage (bias potential) to the row electrodes 48a of all the actuators 22 through the common interconnection 74, and the interconnections 70. The row electrode drive circuit 202 is supplied with one offset power supply voltage from the power supply circuit 208.

The column electrode drive circuit 204 has as many driver output units 210 as the number of all the dots and a plurality of driver ICs 210B each incorporating a certain number of driver output units 210 therein. The column electrode drive circuit 204 is connected to output parallel data signals to the data lines 72 of the display apparatus 10 and supply the data signals to all the dots.

The driver output units 210 are supplied with two data power supply voltages from the power supply circuit 208.

Since the data lines 72 are connected from the column electrode drive circuit 204 to all the dots, it is necessary to keep a wide area for accommodating the data lines 72 therein. It is also necessary to take into account the effect of time constants (signal level reduction) due to interconnection capacitances and resistances resulting from the increased lengths of the data lines 72. In this embodiment, since the display apparatus 10 are divided into 1200 display elements 14, the layout of the data lines 72 extending from the column electrode drive circuit 204 may be considered with respect to each of the display elements 14. Therefore, it is not necessary to keep a wide area for accommodating the data lines 72 therein. Since the interconnection capacitances and resistances may be considered with respect to each of the display elements 14, the caused signal level reduction is negligible.

The two data power supply voltages supplied from the power supply circuit 208 include a high-level voltage which is high enough to displace the actuators 22 downwardly and a low-level voltage which is low enough to allow the actuators 22 to return to their original state.

Each of these data power supply voltages represents an analog signal which changes to a high level and a low level depending on bit information of a bit sequence that makes up dot data. Specifically, if the bit information is logically “0”, then the data power supply voltage becomes a low-level voltage (on signal), and if the bit information is logically “1”, then the data power supply voltage becomes a high-level voltage (off signal).

The signal processing circuit 206 is arranged to control the column electrode drive circuit 204 for controlling gradations at least according to a time modulation process.

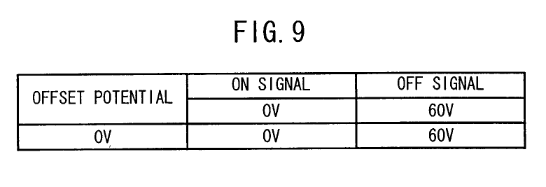

In the above embodiment, the offset potential of 10 V is applied to the row electrodes 48a of the actuators 22. However, as shown in FIG. 9, the offset potential applied to the row electrodes 48a of the actuators 22 may be of 0 V. According to this modification, the number of power supplies used may be reduced by one because the ground potential may be used as the offset potential.

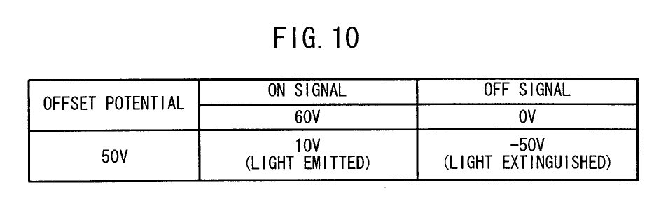

Alternatively, as shown in FIG. 10, the polarity of the applied voltages may be reversed. For example, an offset potential of 50 V may be applied, and on and off signals may have respective potentials of 60 V and 0 V. According to this modification, the polarized direction of the piezoelectric/electrostrictive layer 46 is also reversed.

Further alternatively, with the piezoelectric/electrostrictive layer 46 being pre-polarized in one direction, the pattern (e.g., positive logic) of applied voltages shown in FIG. 7 and the pattern (e.g., negative logic) of applied voltages shown in FIG. 10 may be switched over periodically or temporarily.

One example of switching of the pattern of applied voltages will be described below with respect to the hysteresis characteristics of the actuator 22 using the piezoelectric/electrostrictive layer 46.

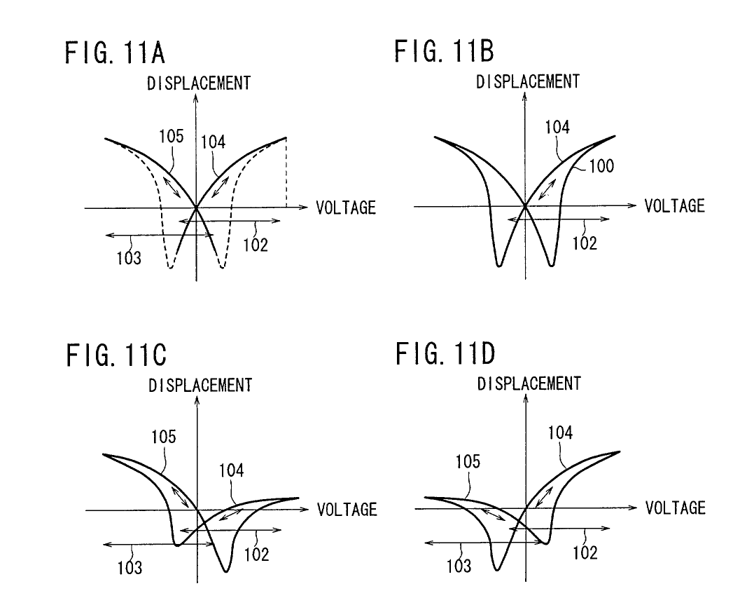

FIG. 11A shows a displacement pattern 104 of the actuator 22 with respect to a pattern 102 of positive logic voltages applied to the piezoelectric/electrostrictive layer 46 of the actuator 22, and a displacement pattern 105 of the actuator 22 with respect to a pattern 103 of negative logic voltages applied to the piezoelectric/electrostrictive layer 46 of the actuator 22. FIG. 11B shows the hysteresis characteristics 100 of the actuator 22. The hysteresis characteristics 100 indicates that even when voltages having different polarities are applied to the piezoelectric/electrostrictive layer 46 of the actuator 22, their displacements are equal to each other if the voltages are of the same absolute amplitude.

When the pattern 102 of positive logic voltages as shown in FIG. 11B is applied to the piezoelectric/electrostrictive layer 46 repeatedly for a long period of time, the displacement pattern 104 of the actuator 22 with respect to the pattern 102 of positive logic voltages changes as shown in FIG. 1C. Therefore, the displacement of the actuator 22 is reduced. The displacement of the actuator 22 may be regarded as a clearance between the optical waveguide plate 20 and the upper surface of the picture element assembly 30 when the light is off.

In the present embodiment, the pattern 102 of positive logic voltages is switched over to the pattern 103 of negative logic voltages periodically or temporarily, thereby compensating for a reduction in the displacement of the actuator 22 to keep the same hysteresis characteristics (see the displacement pattern 105 shown in FIG. 1C) as the displacement pattern 104 developed by the pattern 102 of positive logic voltages shown in FIG. 11B. Therefore, the picture element assembly 30 can be turned on and off with stable durability.

However, even if the pattern 102 of positive logic voltages is reversed into the pattern 103 of negative logic voltages, when the pattern 103 of negative logic voltages is applied for a long period of time, the displacement pattern 105 of the actuator 22 with respect to the pattern 103 of negative logic voltages changes, as shown in FIG. 1D. Therefore, the displacement of the actuator 22 is also reduced in the same manner as described above.

However, it is confirmed that while the actuator 22 is being displaced based on the pattern 103 of negative logic voltages, the hysteresis characteristics (displacement characteristics on positive logic) of the actuator 22 with respect to the pattern 102 of positive logic voltages restores its original state. It is also confirmed that even if the pattern 103 of negative logic voltages is subsequently reversed into the pattern 102 of positive logic voltages, the displacement characteristics on negative logic restores its original state. Consequently, in order to keep a required displacement over time, it is necessary to switch over the voltage patterns 102, 103 periodically or temporarily.

The voltage patterns 102, 103 may be switched over within a period in which the required displacement is maintained. Within that period, e.g., within an actual display period in which an image is displayed on the display apparatus 10, the actuator 22 may be displaced according to the pattern 102 of positive logic voltages. In a non-display period in which no image is displayed on the display apparatus 10, the actuator 22 may be displaced according to the pattern 103 of negative logic voltages.

More specifically, as shown in FIG. 8, the voltage polarity switching circuit 212 of the drive device 200 may switch over the polarity of the voltage supplied from the power supply circuit 208 to the actuator 22 as required, for thereby apply the patterns 102, 103 of positive and negative logic voltages to the actuator 22. The patterns 102, 103 of positive and negative logic voltages thus switched over make it possible for the actuator 22 to be continuously displacement as desired.

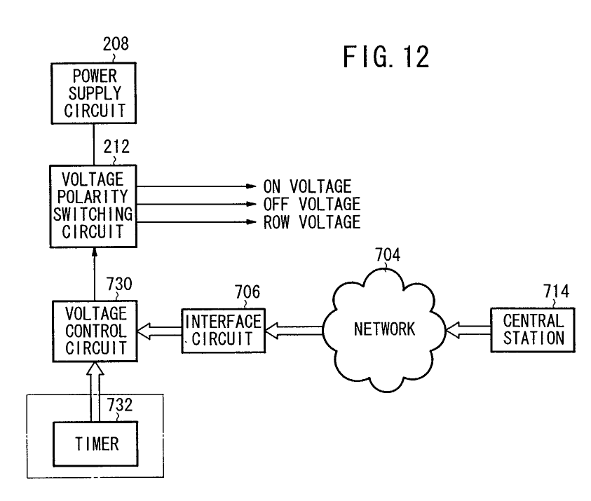

Methods according to some specific examples for switching patterns of applied voltages using the voltage polarity switching circuit 212 will be described below with reference to FIGS. 12 to 14.

In a method according to a first specific example, as shown in FIG. 12, the power supply circuit 208 and the voltage polarity switching circuit 212 jointly make up a voltage generating system for generating a variable voltage. The voltage polarity switching circuit 212 outputs the voltages supplied from the power supply circuit 208 as an on voltages, an off voltage, and a row voltage. The voltage polarity switching circuit 212 also has a function to adjust the magnitudes of the on voltages, the off voltage, and the row voltage based on a control signal from a voltage control circuit 730. For example, the voltage polarity switching circuit 212 switches between the pattern (e.g., positive logic) of applied voltages shown in FIG. 7 and the pattern (e.g., negative logic) of applied voltages shown in FIG. 10. The voltage polarity switching circuit 212 adjusts the magnitudes of the voltages according to a voltage adjusting process using a variable resistor (not shown), for example.

In the first specific example, an interface circuit 706 for receiving information as to voltage changes from a central station 714 via a network 704 is connected to a voltage control circuit 730. The voltage control circuit 730 controls the variable resistor based on the information from the interface circuit 706 to set the on voltage to a desired voltage, and is connected to the voltage polarity switching circuit 212.

When the display apparatus 10 is shipped from the factory, it may be set to the pattern (e.g., positive logic) of applied voltages shown in FIG. 7 by the voltage polarity switching circuit 212. Thereafter, if a brightness change is used as information indicative of a deterioration of the displacing action of the actuators, then the data, measured by a CCD camera, for example, of brightness of a monitor display unit used for monitoring brightness changes in the factory, are managed by the central station 714. The central station 714 can determine a deterioration of the displacing action of the actuators from a brightness change based on the measured data managed thereby. The central station 714 transmits the information as to voltage changes via the network 704 to those display apparatus 10 which have reached a time when the actuator displacement is likely to decrease, among display apparatus 10 which are installed in various regions. When the voltage control circuit 730 in each of those display apparatus 10 receives the information from the central station 714 through the interface circuit 706, the voltage control circuit 730 outputs a control signal indicative of a voltage polarity change to the voltage polarity switching circuit 212.

In response to the control signal from the voltage control circuit 730, the voltage polarity switching circuit 212 adjusts the voltages from the power supply circuit 208. Specifically, the voltage polarity switching circuit 212 switches the on voltage, the off voltage, and the row voltage according to a pattern of applied voltages (e.g., negative logic) shown in FIG. 10.

If the pattern of positive logic voltages is continuously applied to the actuator 22 further, the displacing action of the actuator 22 is deteriorated. By changing the pattern of applied voltages from the pattern of positive logic voltages to the pattern of negative logic voltages, the deterioration in the displacing action of the actuator 22 is compensated for, and the displacement of the actuator 22 restores its initial state.

In the above specific example, the time when the displacement of the actuator 22 is likely to deteriorate is determined using the monitor display unit in the factory. Alternatively, a change in the brightness of the display apparatus 10 may be indicated via e-mail or telephone by the supervisor at the site where the display apparatus 10 is installed, and the central station 714 may determine a deterioration of the displacing action based on the indicated change in the brightness and then transmit information as to voltage changes via the network 704 to the display apparatus 10.

A method according to a specific second example will be described below. In this method, the display apparatus 10 itself has a function to change voltages. For example, a plurality of items of time information representing times when the displacement of the actuators is likely to deteriorate are stored in a plurality of registers in the voltage control circuit 730. When time information from a timer 732 connected to the voltage control circuit 730 agrees with one of the items of time information stored in the registers, the voltage control circuit 730 outputs a control signal to the voltage polarity switching circuit 212, which changes the on voltage, the off voltage, and the row voltage.

In a method according to a third specific example, dummy actuators 22 are fabricated in some of the display elements 14, e.g., those display elements 14 provided in the peripheral edge of the display screen. Displaced states of these dummy actuators 22 are detected by sensors (stain gages or the like), and used to determine whether displacements of the dummy actuators 22 at the time they are turned on are deteriorated or not.

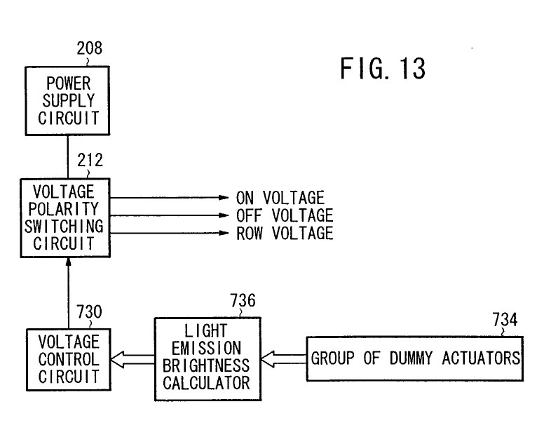

Specifically, as shown in FIG. 13, a group 734 of many dummy actuators 22 supply detected signals from the associated sensors to a light emission brightness calculator 736, which calculates an approximate value of the overall brightness of the display screen from the supplied detected signals. A threshold value is stored in a register in the voltage control circuit 730. When the approximate value of the brightness calculated by the light emission brightness calculator 736 exceeds the threshold value, the voltage control circuit 730 judges the overall displacement of the actuators as being deteriorated. The voltage control circuit 730 then outputs a control signal to the voltage polarity switching circuit 212, which changes the on voltage, the off voltage, and the row voltage.

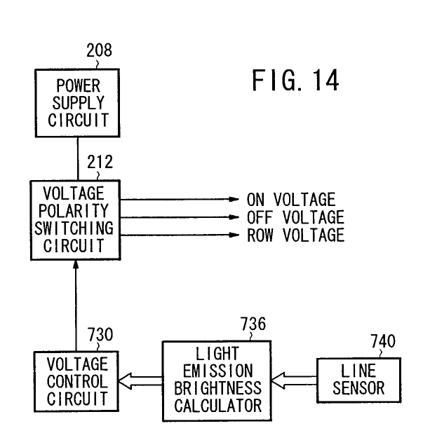

FIG. 14 shows a method according to a fourth specific example. In FIG. 14, a line sensor 740 is provided for horizontally scanning the display screen of the display apparatus 10. While a certain image is being periodically displayed on the display apparatus 10, the line sensor 740 is energized to detect the light emission brightness of the display apparatus 10.

An image signal sequentially outputted from the line sensor 740 is supplied to the light emission brightness calculator 736, which calculates the overall brightness of the display screen from the supplied image signal. A threshold value is stored in a register in the voltage control circuit 730. When the brightness calculated by the light emission brightness calculator 736 exceeds the threshold value, the voltage control circuit 730 judges the overall displacement of the actuators as being deteriorated. The voltage control circuit 730 then outputs a control signal to the voltage polarity switching circuit 212, which changes the on voltage, the off voltage, and the row voltage.

The methods according to the specific examples shown in FIGS. 12 to 14 make it possible to perform maintenance services on the display apparatus 10 automatically via the network 704 or on a self-diagnostic basis. Usually, when a maintenance operation on the display apparatus 10 which includes a number of display elements 14 is performed, if the maintenance operation may be simple routine work, a maintenance person is sent to the site of the display apparatus 10 to service or repair the display apparatus 10. Therefore, the cost of maintenance is so large that it presents an obstacle to widespread use of display apparatus 10.

However, the above methods according to the specific examples shown in FIGS. 12 to 14 automatize a simple maintenance process such as for brightness adjustment, and hence are effective in greatly reducing the cost of maintenance. By establishing maintenance fees depending on various modes of use for even one brightness adjustment session, maintenance services highly depending on the need of customers can be provided. Therefore, the above methods contribute to widespread use of display apparatus 10.

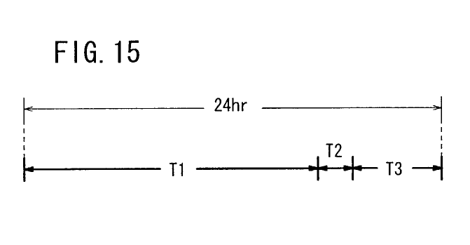

A process of periodically applying a refresh signal to the display apparatus 10 (refresh operation) will be described below with reference to FIGS. 15 to 18. First, some definitions are given below. As shown in FIG. 15, of 24 hours a day, a time zone in which images are displayed, i.e., a time zone in which image signals supplied on radio waves or by an image transmitting apparatus are displayed outdoors or indoors, is referred to as an active time zone T1, another time zone except for the active time zone T1 is referred to as an inactive time zone T2 in turn-on time zone, and a time zone in which the display apparatus 10 is turned off is referred to as a turn-off time zone T3.

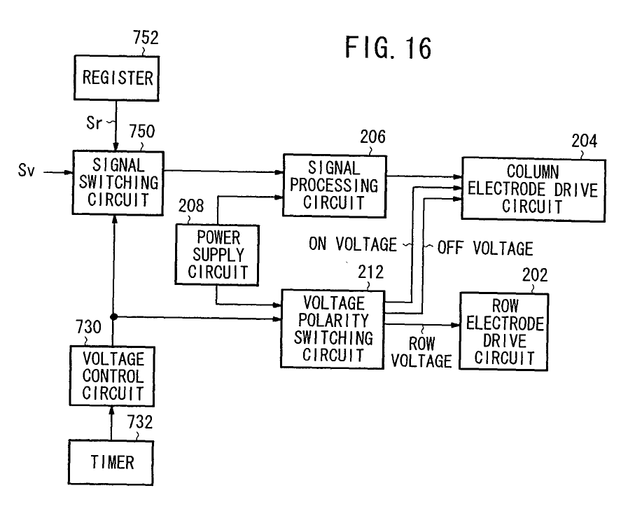

In the refresh operation, a refresh signal is periodically applied to the display apparatus 10 in the inactive time zone T2. Specifically, as shown in FIG. 16, a signal switching circuit 750 is connected with the signal processing circuit 206, and a control signal from the voltage control circuit 730 is supplied to the voltage polarity switching circuit 212 and the signal switching circuit 750.

The signal switching circuit 750 switches between an image signal Sv supplied on radio waves or by an image transmitting apparatus and a signal, i.e., a refresh signal having a certain frequency, Sr from a register 752 based on the control signal from the voltage control circuit 730.

The voltage control circuit 730 has a register which stores the active time zone T1, the inactive time zone T2, and the turn-off time zone T3. The voltage control circuit 730 compares time information from a timer 732 with the information stored in the register, and outputs a control signal depending on the present time zone.

When the active time zone T1 is reached, the voltage polarity switching circuit 212 adjusts the voltages from the power supply circuit 208 to change the on voltage, the off voltage, and the row voltage to the pattern (e.g., positive logic) of applied voltages shown in FIG. 7. With the voltages thus switched to the pattern of applied voltages, the signal switching circuit 750 supplies the image signal Sv to the signal processing circuit 206.

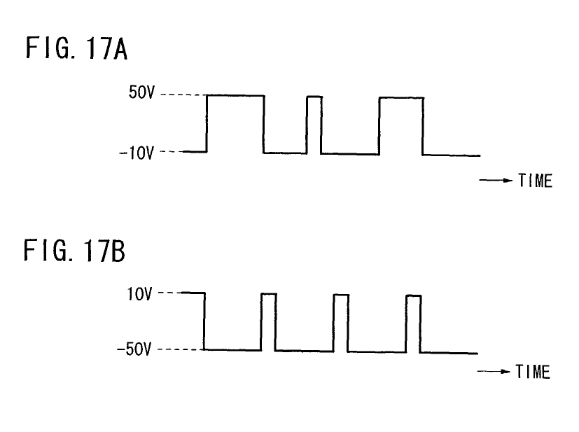

In the active time zone T1, therefore, the display screen of the display apparatus 10 displays an image according to the image signal Sv. In terms of one picture element (actuator 22), as shown in FIG. 17A, the waveform of the voltage applied to the actuator 22 varies depending on the image signal supplied to the picture element.

When the inactive time zone T2 is reached, the voltage polarity switching circuit 212 adjusts the voltages from the power supply circuit 208 to change the on voltage, the off voltage, and the row voltage to the pattern (e.g., negative logic) of applied voltages shown in FIG. 10. With the voltages thus switched to the pattern of applied voltages, the signal switching circuit 750 supplies the refresh signal Sr from the register 752 to the signal processing circuit 206. In the inactive time zone T2, the waveform of the voltage applied to each of the picture elements (the actuators 22) has a constant frequency. At this time, the light source should preferably be de-energized to stop light emission.

When the turn-off time zone is reached, the power supply circuit is instructed to be turned off, stopping the supply of electric energy and light emission from the light source.

The refresh signal Sr should preferably comprise a pulse signal having a constant frequency and a duty ratio of 10%, for example. In the present embodiment, as shown in FIG. 17B, when the refresh signal Sr is supplied to the signal processing circuit 206, the pulse duration of a voltage (10 V in this case) corresponding to light emission becomes 10% of the pulse period.

An experimentation will be described below. In the experimentation, reductions in the displacement of actuators 22 according to Comparative Example and Inventive Example were measured.

In Inventive Example, the active time zone T1 was 18 hours, the inactive time zone T2 was 1 hour, and the turnoff time zone T3 was 5 hours. In Comparative Example, the active time zone T1 was 18 hours, and the turn-off time zone T3 was 6 hours. In the refresh operation according to Inventive Example, the refresh signal supplied to the signal processing circuit 206 had a duty ratio of 10% and a frequency which is the same as the frame frequency (60 Hz).

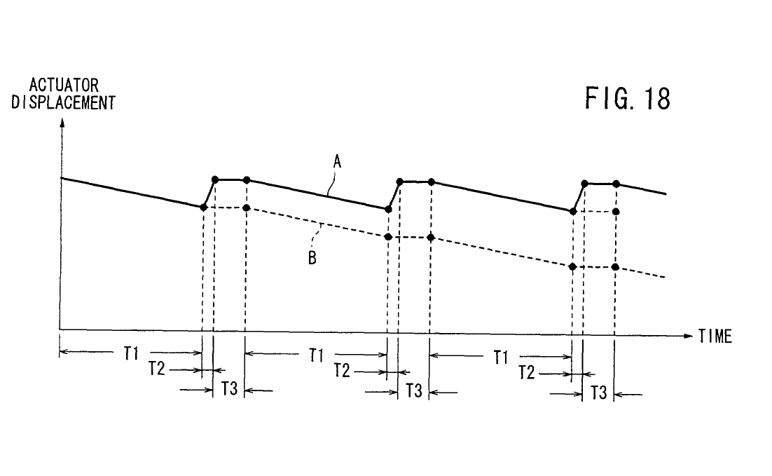

Results of the experimentation are shown in FIG. 18. In FIG. 18, changes in the actuator displacement according to Inventive Example are indicated by a solid-line curve A, and changes in the actuator displacement according to Comparative Example are indicated by a broken-line curve B. It can be understood from the results of the experimentation that the actuators in Inventive Example maintained a displacement required to extinguish the light emission by performing the refresh operation, and the displacement of the actuators in Comparative Example was gradually reduced and the light emission was not completely extinguished.

Preferred details for increasing the above effect in the refresh operation, i.e., the ability to compensate for a reduction in the displacement of the actuators 22, will be described below.

The ratio of the time in which the voltage for causing light emission is applied to the pulse period, i.e., the duty ratio, of the waveform of the refresh signal Sr, should preferably be 50% or less, and more preferably from 0.1% to 30%. The effect in the refresh operation can be increased by setting a time in which the voltage for causing light emission is applied, even if it is small, as compared with the duty ratio of 0% (the time in which the voltage for causing light emission is applied is 0).

The frequency of the refresh signal Sr should preferably be the same as the frame frequency (60 Hz) or higher than the frame frequency, e.g., 600 Hz.

In the refresh operation, it is preferable to increase the range of voltages applied to the actuators 22. For example, in the normal operation, the voltage applied to emit light is −10 V and the voltage applied to the light off is 50 V, and in the refresh operation, the voltage applied to emit light is 15 V and the voltage applied to the light off is —60 V.

In the refresh operation, the display apparatus should preferably be operated at a temperature equal to or higher than in the normal operation because at lower temperatures, the refreshing effect, i.e., the ability to compensate for a reduction in the displacement of the actuators 22, would be reduced.

The temperature may be increased by increasing the frequency of the refresh signal Sr or increasing the voltage range, or inactivating a cooling system or reducing the output of the cooling system, or installing a heater.

The method of compensating for a deterioration of the displacing action of a laminated piezoelectric/electrostrictive actuator according to the present invention is not limited to the above embodiments, but is also applicable to various apparatus which employ the above actuator.

In the method of compensating for a deterioration of the displacement of a laminated piezoelectric/electrostrictive actuator according to the present invention, as described above, the polarity of a voltage applied to the electrode layers of the actuator is periodically or temporarily switched to keep the magnitude of the displacement for thereby extending the service life of the actuator.

With the service life of the actuator being extended, the service life of the apparatus which employs the actuator is also extended and the reliability of the apparatus is increased.

Although certain preferred embodiments of the present invention have been shown and described in detail, it should be understood that various changes and modifications may be made therein without departing from the scope of the appended claims.

What is claimed is:

1. A method of compensating for a deterioration of the displacement of a laminated piezoelectric/electrostrictive actuator which comprises electrode layers formed by a film fabrication process and a piezoelectric/electrostrictive layer of ceramics, mounted on a ceramic base, comprising the step of:
periodically or temporarily switching the polarity of a voltage applied to said piezoelectric/electrostrictive actuator through said electrode layers.

2. A method according to claim 1, wherein the polarity of said voltage is periodically or temporarily switched by controlling a voltage polarity switching circuit which is connected between a source for generating the voltage applied to said piezoelectric/electrostrictive actuator layer through said electrode layers and said electrode layers.

3. A method according to claim 1, further comprising the steps of:
monitoring a displaced state of said piezoelectric/electrostrictive actuator; and
switching the polarity of the voltage applied to said piezoelectric/electrostrictive actuator when a displacing action of said piezoelectric/electrostrictive actuator is deteriorated.

4. A method according to claim 3, further comprising the steps of:
providing a monitoring piezoelectric/electrostrictive actuator separately from the piezoelectric/electrostrictive actuator in use; and
switching the polarity of the voltage applied to said piezoelectric/electrostrictive actuator in use based on a deterioration of the displacement of said monitoring piezoelectric/electrostrictive actuator.

5. A method according to claim 4, further comprising the step of:
remotely switching the polarity of the voltage applied to said piezoelectric/electrostrictive actuator in use.

6. A method according to claim 1, further comprising the steps of:
providing a timer; and
switching the polarity of the voltage applied to said piezoelectric/electrostrictive actuator when one of a plurality of items of time information representing times when the displacement of the piezoelectric/electrostrictive actuator is likely to deteriorate agrees with time information indicated by said timer.

7. A method according to claim 1, wherein said piezoelectric/electrostrictive actuator comprises a piezoelectric/electrostrictive actuator for use in a display apparatus for displaying an image depending on an image signal based on the displacement of the piezoelectric/electrostrictive actuator, further comprising the step of:
switching the polarity of the voltage applied to said piezoelectric/electrostrictive actuator between a period in which said image is displayed and a period in which said image is not displayed.

8. A method according to claim 7, further comprising the step of:
applying a voltage based on a refresh signal having a constant frequency to said piezoelectric/electrostrictive actuator in at least a portion of said period in which said image is not displayed.

9. A method according to claim 8, wherein said refresh signal has a duty factor in a pulse waveform having a pulse period, and said voltage applied to said piezoelectric/electrostrictive actuator is based on said duty factor in which the period for emitting light is less than 50% of said pulse period.

10. A method according to claim 8, wherein the frequency of said refresh signal is equal to or higher than the frame frequency of the image signal.

11. A method according to claim 8, wherein a range of voltages applied to said piezoelectric/electrostrictive actuator based on said refresh signal is greater than a range of voltages applied to said piezoelectric/electrostrictive actuator in the period in which said image is displayed.

12. A method according to claim 8, wherein a temperature at which the voltage is applied to said piezoelectric/electrostrictive actuator based on said refresh signal is equal to or higher than a temperature at which the voltage is applied to said piezoelectric/electrostrictive actuator in the period in which said image is displayed.
